(19) United States
(12) Patent Application Publication
(10) Pub. No.: US 2010/0011289 A1
(43) Pub. Date: Jan. 14, 2010

(54) METHOD AND SYSTEM FOR DOCUMENT VIEWING

(75) Inventors: Alain BENZAKEN, Stamford, CT (US); Gregg DONOVAN, New York, NY (US); Zhi-Da ZHONG, Brooklyn, NY (US); Drew SCHWARTZ, New Rochelle, NY (US)

Correspondence Address: PILLSBURY WINTHROP SHAW PITTMAN, LLP, P.O. BOX 10500, MCLEAN, VA, 22102, US

(73) Assignee: THELADDERS.COM, INC., New York, NY (US)

(21) Appl. No.: 12/170,057

(22) Filed: Jul. 9, 2008

(51) Int. Cl. G06F 3/14; G06F 3/048

(52) U.S. Cl. 715/273; 715/760

(57) ABSTRACT

In one embodiment, a computer-implemented method of converting a document to an image set includes receiving the document; generating a conversion specification with a unique document identifier and a set of image parameters; combining the conversion specification and the stored document into a conversion task object; generating the image set using the conversion task object; and providing the generated image set to an image server. In another embodiment, a computer-implemented system for viewing documents includes a first node configured to receive a document file from a first user and generate a conversion specification using the unique identifier and a set of image parameters relating to the document file. A conversion feeder receives and converts the conversion specification and the document file into a conversion task object. At least one converter generates an image set including one or more images related to the document file by using the conversion task object.

### BACKGROUND

The use of Internet or Web-based applications and services has greatly expanded over the last several years. For example, there are several Web-based employment services in which job applicants and potential employers or their intermediaries may exchange job-related information and documents.

One problem with the use or exchange of such documents is related to viewing of documents by users. The devices used by different users wishing to view documents in the system may have different viewing capabilities, e.g., screen resolution and/or bandwidth. Adapting viewing capabilities for different users is generally a manual process, and which may be time-consuming and/or inefficient.

Another problem is that collaboration between different users with respect to a single document may be difficult when the review is conducted online, for example, by two members of a Human Resources Department of a potential employer.

### SUMMARY

In one embodiment, a computer-implemented system for viewing documents includes a first node configured to receive a document file from a first user, assign a unique identifier thereto, and generate a conversion specification comprising the unique identifier and a set of image parameters relating to the document file; a conversion feeder configured to receive the conversion specification and the document file and convert the conversion specification and the document file into a conversion task object, at least one converter operatively coupled to the conversion feeder and configured to generate, from the conversion task object, an image set comprising one or more images related to the document file; and an image server that receives the generated image set.

In another embodiment, a computer-implemented method of converting a document to an image set comprising one or more images includes receiving a file containing the document; generating a conversion specification comprising a unique document identifier and a set of image parameters associated therewith; combining the conversion specification and the stored document into a conversion task object; generating said image set of one or more images using the conversion task object; and providing said generated image set to an image server.

In another embodiment, a Web-based method of viewing a document includes receiving a document retrieval request from a user, said document retrieval request comprising information relating to a particular document and image viewing capabilities and/or preferences indicated by the user; selecting an image set comprising one or more images from an image server based, at least in part, on the particular document and the available image viewing capabilities and/or preferences; and providing the selected image set to the user, wherein the selected image set is optimized at least with respect to the image viewing capabilities and/or preferences indicated by the user.

In a further embodiment, a document image converter includes an input configured to receive a conversion task from a client application, wherein the conversion task comprises a conversion specification and a document, and wherein the conversion specification comprises a unique document identifier and a set of image parameters associated with the document; a conversion controller; and a renderer operatively coupled to the conversion controller, wherein the renderer accesses the document and generates a set of images comprising one image for each page of the document, wherein said conversion controller provides said set of images to said client application.

In another embodiment, a document browser application includes a software interface with an Internet Web browser that enables the application to run within a Web browser window; a user interface enabled with a host computer system through which a user sends a document retrieval request to a server application, said document retrieval request at least comprising information relating to viewing capabilities of the host computer system, said user interface comprising computer executable code therein which, when executed by the host computer system enables user-interactive controls for navigating multiple pages of a retrieved document, user-initiated collaboration with other users related to the retrieved document, and display of one or more pages of the retrieved document.

### BRIEF DESCRIPTION OF THE DRAWINGS

Various exemplary embodiments of this disclosure will now be described with reference to the accompanying drawings in which:

FIG. 1 illustrates an embodiment of a document upload and conversion system;

FIG. 2 depicts an embodiment of a document viewing system including a document browser installed in a web browser; and

FIG. 3 provides a block diagram of an embodiment of a document-image converter.

### DETAILED DESCRIPTION

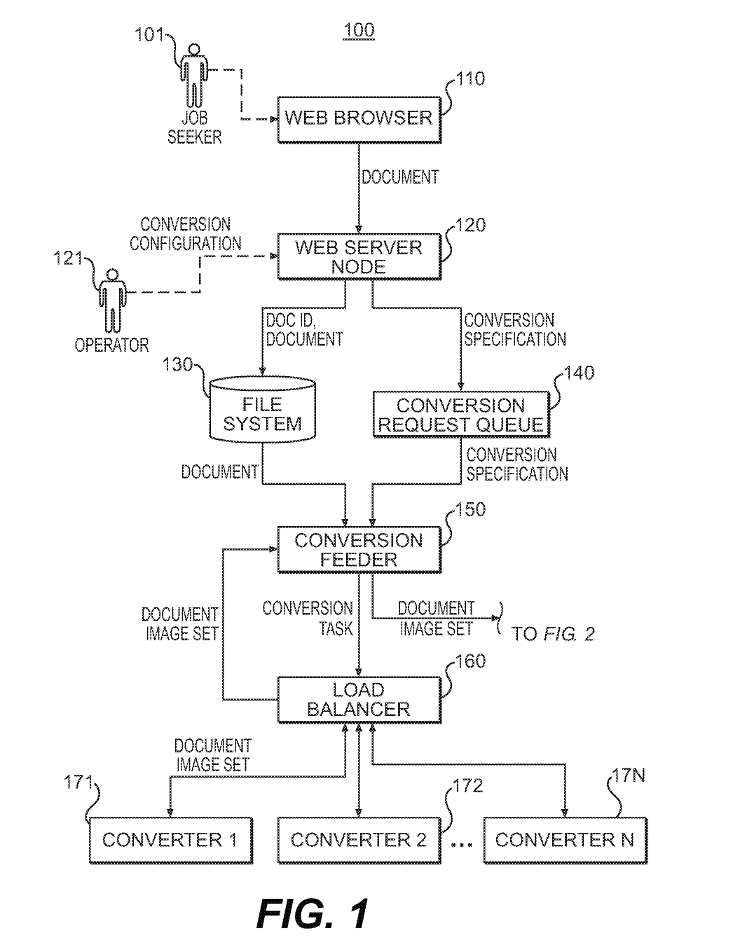

Turning now to FIG. 1, one embodiment of document upload and conversion system 100 includes Web browser 110 through which job seeker 101 may upload a document, e.g., a resume from a job seeker, to a first node, e.g., Web server node 120. Web browser 110 may be a conventional web browser such as Internet Explorer® or Firefox®, and which is connected to the Internet. Although FIG. 1 implies use of the Internet, the system and method of the present disclosure may also be useful in a private network arrangement, and is not limited to the Internet. Web server node 120 may be implemented in a variety of ways known in the art, and can be implemented by a personal computer (PC), more specialized server hardware, or by a workstation. In this context, a “computer” is intended to have a broad definition that includes various devices with data processing capability, such as mobile phones, electronic paper/readers, personal data assistants (PDA), and tablet or laptop PCs, for example.

Operator 121 may view the uploaded document and provide control parameters related to a desired conversion configuration. The operator may be a system administrator or software developer, but the action to set the basic image parameters for desired image sets is generally performed at the behest of a business owner that is operating the system.

An application program running in Web server node 120 may provide functionality that assigns a unique ID to the uploaded document and then saves the uploaded document and its related document ID to file system 130. The computer code can be written in a number of languages or mix of languages, for example, a mix of C#, Java, and C++ libraries. However, the choice of language does not limit the inventive concept described herein.

File system 130 may be implemented in a variety of known ways, for example by a hard drive or removable storage or others storage devices. The data may be formatted in a desired manner that lends itself to be stored in a structured database.

The application program running in Web server node 120 may also provide functionality via computer code running in a processor configured to create a conversion specification. In one aspect of this embodiment, the conversion specification includes a document ID and a set of image parameters related to the identified document. Thus, for each uploaded document, a corresponding conversion specification may be developed, and related to a corresponding document by the document ID, for example. The conversion specification may then be inserted into optional conversion request queue 140 to await further processing. Conversion request queue 140 may be implemented in a variety of known ways, including use of a “first in, first out” (FIFO) stack architecture, for example.

Conversion feeder 150 may optionally be configured to poll conversion request queue 140 and, in response to the polling, to receive a particular conversion specification and retrieve the corresponding document from file system 130. Conversion feeder 150 may be implemented by one or more processors (not shown) executing computer code that combines the conversion specification and the corresponding document file into a conversion task object that is sent to a converter e.g., converter 171 that converts the conversion task object into one or more document images. Conversion feeder 150 may execute jobs as a batch process without operator intervention. Alternatively, conversion feeder 150 may perform its functions in an interactive manner with an operator providing various inputs. Although the conversion task is referred to as an “object” as that term may be understood in object-oriented programming, the conversion task may be implemented in a variety of ways outside of an object-oriented programming construct, as would be known to a person of ordinary skill in the art.

In one aspect of this embodiment, multiple converters 171, 172, . . . , and “17n” may be controlled by optional load balancer 160. Load balancer 160 may be used to evaluate the relative operational loading between each of the converters 171, 172, etc., and to assign a specific converter the task of converting a downloaded document into an image set that includes one or more document images. The converter(s) may be implemented by one or more processors executing computer software code that takes a conversion task object and produces an image set using the underlying document and image parameters relating to the underlying document, both of which may be found in the conversion task object.

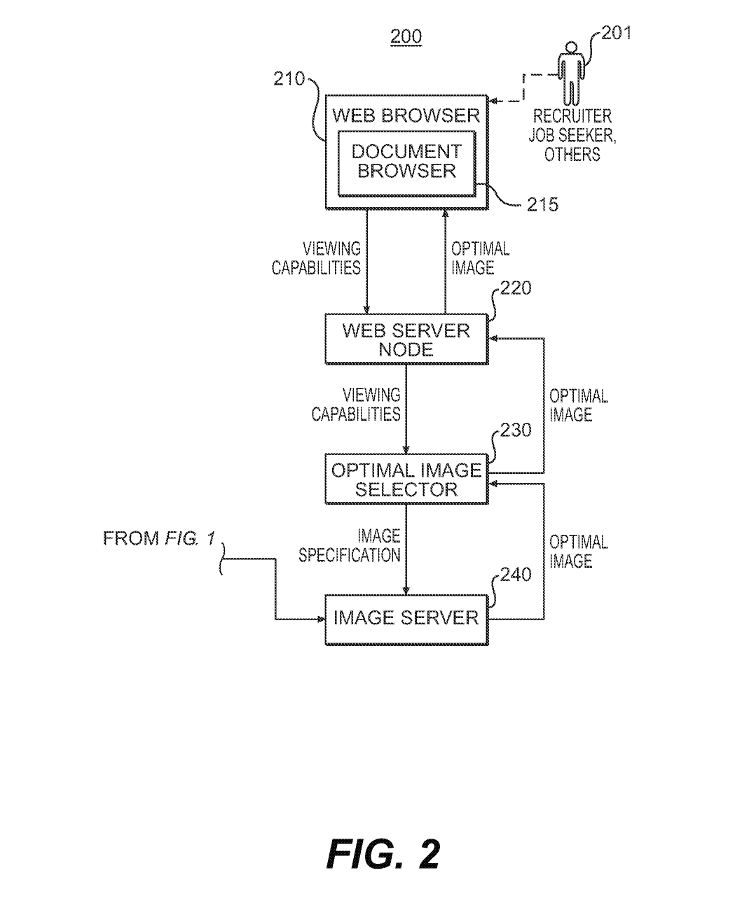

Once a converter has completed the conversion process, the image set is provided to conversion feeder 150, either directly from a converter, or through load balancer 160. The image set may include one or more images relating to the underlying document. Conversion feeder 150 may then provide the image set to image server 240, as shown in FIG. 2, for future access by one or more application programs that may be running in Web server node 120, or in another node that may have access to image server 240. Image server 240 may be implemented in a variety of ways known in the art, and can be implemented by a personal computer, more specialized server hardware, or by a workstation, for example.

Turning now to FIG. 2, document viewing system 200 may be accessed by user 201 through web browser 210 having document browser 215 contained therein. When document viewing system 200 is employed in an employment service capacity, user 201 may be a job recruiter, a job seeker, or other interested party. Document browser 215 may be implemented by program code or a program “stub”, such as a browser plug-in module installed in web browser 210. Although not shown for the sake of simplicity, Web browser 210 may also include a visual display for use by user 201. Document browser 215 may provide a document retrieval request to a second node, e.g., Web server node 220 over a network, for example the Internet or a private network. When employed in an employment service capacity, the document retrieval request may be a resume retrieval request, and may also include information concerning the viewing capabilities and/or desired viewing characteristics of user 201.

Web server node 220 may provide desired viewing capabilities to optimal image selector 230 which may include one or more processors (not shown) configured to run an application program that provides functionality that selects an image or in a set from image server 240 that utilizes display characteristics in accordance with preferred viewing characteristics of user 201, or hardware-limited viewing capabilities associated with the host computer system (not shown) in which Web browser 210 is operating.

After selection of an optimal image or image set from image server 240, optimal image selector 230 provides the optimal image(s) to Web server node 220 for further communication to Web browser 210 over the network. Web browser 210 then provides the optimal image(s) to document browser 215 for display.

In one embodiment, document browser 215 may be viewed as a “client”, as that term is known and appreciated in client-server systems.

Document browser 215 may offer interactive controls for navigating multiple pages and documents, at the discretion or desire of user 201. In addition, document browser 215 also includes functionality that allows user 201 to share the document being viewed, e.g., a resume, with other users (not shown), and to collaborate with the other users in terms of discussion of, or questions pertaining to the document being viewed. Furthermore, document browser 215 may be configured to include additional functionality by way of computer code implemented in the associated computer program that allows annotation data or supplementary information pertaining to the document being viewed to be displayed adjacent to, or superimposed on the document image being viewed. This may be of particular value in an employment service application in which a candidate for employment is evaluated and/or screen a multiple individuals, for example by Human Resources Department personnel.

Such annotation or supplementary data may be added to the optimized images and stored in a storage medium such as a database, for example. The use of annotation data allows users to collaborate with each other by overlaying notes, comments, or other data on top of, or adjacent to the image. The annotation data may be stored separately from the images stored in image server 240, and correlated with one or more images by use of the document ID, for example. By way of a non-limiting example of one aspect of this embodiment, an employment recruiter may annotate a resume before forwarding it to another recruiter in his company.

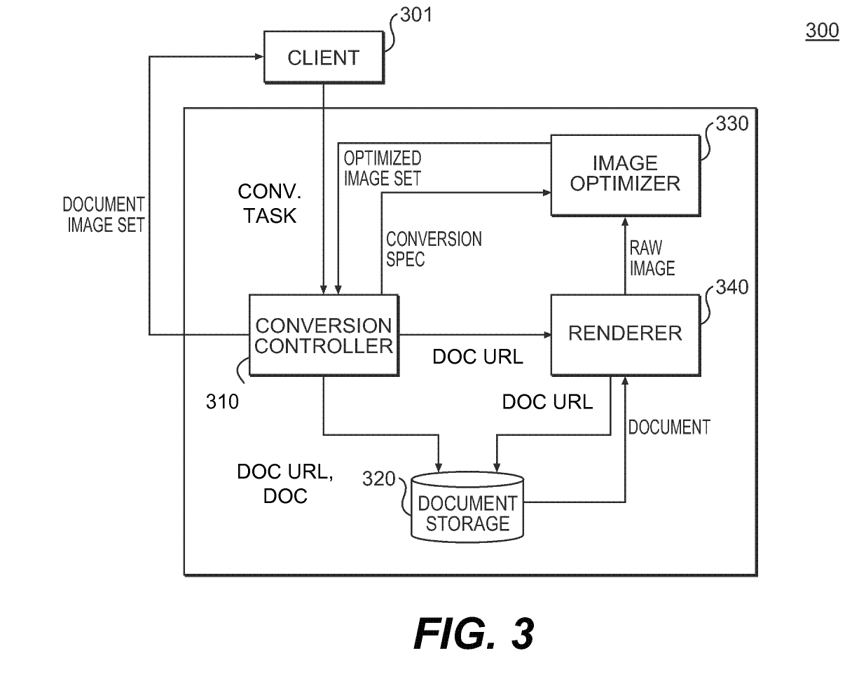

Turning now to FIG. 3, an exemplary embodiment of a document-image converter 300 is provided. Document-image converter 300 may be used as converter 171, as shown in FIG. 1. Client 301 may represent, for purposes of this discussion, conversion feeder 150, or load balancer 160.

Document-image converter 300 includes conversion controller 310 that receives a conversion task or conversion task object from client 301. The output of converter 300 is a set of optimized document images provided to client 301, which is not considered to be part of converter 300.

Conversion controller 310 stores the document in document storage element 320, which may be a conventional memory or storage device implemented for temporary storage, and which may also be configured as a database. Conversion controller 310 passes a location of the newly-stored document to renderer 340. The location may be passed as an address, e.g., a memory address, or as a uniform resource locator (URL) address, for example. Renderer 340 uses the provided address to load the stored document from document storage element 320. Renderer 340 may include one or more processors executing computer code configured to generate a set of raw images relating to the document, e.g., one for each page of the document.

As is known the art, “rendering” may be considered to be a process of computing in which the contents of a document, image, or other file are interpreted so that it can be provided in a form desired for display or playback on a computer. A more specific definition of image rendering related to rendering documents or files into images is a process of computing in which the contents of a document, image, or other file are interpreted to produce an image, often in a bitmapped form.

Renderer 340 then provides the raw image(s) to image optimizer 330 to develop optimized images, using parameters found in the conversion specification provided to the image optimizer by conversion controller 310. For each image specification in the conversion specification, image optimizer 330 converts the raw image into an optimized image. Upon completion of image optimization by image optimizer 330 the set of optimized images are returned to conversion controller 310 which, in turn, provides a document image set, e.g., an optimized image set, to client 301. Converter 300 may provide the image set as one or more images, for example. Although the exact type of image that is provided is not crucial in understanding the inventive concept, the images may be provided in various formats, e.g., Portable Network Graphics (PNG) format, Tagged Image File (TIF), Graphics Interchange Format (GIF), or Joint Photographic Experts Group (JPEG/JPG), Portable Document Format (PDF), or other known or contemplated image file format. Each of these image types has relative advantages and disadvantages for various applications, including web-based applications, as would be appreciated by a person with skill in the art.

In this context, “raw” images may be broadly interpreted as unoptimized images in terms of desired image parameters. Raw images may be larger in file size and/or height/width, or may lack the desired clarity or other desired attribute in comparison to an “optimized” image.

Further aspects of the above-discussed inventive concepts and related embodiments will be discussed below. Conversion request queue 140 may be optionally utilized, depending on system loading, to receive the conversion specification and, in response to a polling request, provide the conversion specification to the conversion feeder. In other words, the conversion specification may be provided directly to conversion feeder 150, depending on system requirements. Furthermore, the polling request may be provided to conversion request queue 140 by conversion feeder 150.

Another embodiment in which a computer-implemented method of converting a document to an image set comprising one or more images will now be discussed, generally along the lines of the discussion of the system of FIGS. 1 and 2. In this embodiment, the method includes receiving a file containing the document and generating a conversion specification that includes a unique document identifier and a set of image parameters associated with the document. The conversion specification and the stored document are combined into a conversion task object. An image set of one or more images are generated using the conversion task object. Thereafter, the generated image set may be provided to an image server which may be accessible through the Web or over a private network.

In a further aspect of this embodiment, the conversion specification is provided to an optional conversion request queue prior to generation of the conversion task object. The conversion request queue is polled, and the conversion task object is created by combining the polled conversion specification and the document.

Optionally, before generating the image set, a conversion load of a number of converters may be evaluated, and one of the converters may be assigned to convert the conversion task object into an image set based upon a relative conversion load of the converters.

In addition, the method may also include configuring a set of conversion parameters through an operator interface, and the operator interface may be enabled through a Web server in communication with the Internet. The method may further include uploading the document to a Web server over the internet. Examples of image conversion parameters that might be desirable to be set includes conventionally known parameters such as bit depth (or other color-related parameters), and/or height/width of the desired optimized images.

Furthermore, the method may include annotating one or more images of the image set with annotation data, and the annotation data may be stored, e.g., separately from the image server.

In another embodiment, a Web-based method of viewing a document includes receiving a document retrieval request from a user. The document retrieval request may include information relating to a particular document and image viewing capabilities and/or preferences indicated by the user. An image set that includes one or more images from an image server may be selected based, at least in part, on the particular document and the available image viewing capabilities and/or preferences of the user or of the user's system. A selected image may be provided to the user and it may be optimized at least with respect to the image viewing capabilities and/or preferences indicated by the user. As above, the document retrieval request may be provided to a Web server by the user, and the document may include a resume of a job seeker, and/or the user may be a recruiter.

Furthermore, the document retrieval request may include a request for multiple documents. In addition, one or more images of a particular document may be shared with multiple users.

In another aspect of this embodiment, collaboration between the user and one or more other users may be enabled to allow group review and consultation regarding the particular document. In this regard, supplemental information may be superimposed on one or more of the images in the image set and the supplemental information may be stored.

In another embodiment depicted, at least in part, in FIG. 2, a document browser application includes a software interface with an Internet Web browser that enables the application to run within a Web browser window. A user interface is enabled with a host computer system through which a user sends a document retrieval request to a server application. The document retrieval request may include information relating to viewing capabilities of the host computer system, for example. The user interface may be configured to include computer executable code which, when executed by the host computer system, enables user-interactive controls to navigate multiple pages of a retrieved document, allow user-initiated collaboration with other users related to the retrieved document, and to display of one or more pages of the retrieved document. Optionally, the document retrieval request may include a request to retrieve multiple documents. The user-interactive controls may be configured to enable navigation of the multiple documents and any pages contained therein.

In one aspect, the user-initiated collaboration includes annotating a retrieved document with supplemental information which may be provided to a display of the host computer system. Furthermore, the supplemental information may be superimposed on or placed adjacent to an image of the retrieved document on the display.

As in other embodiments discussed above, retrieved documents may include a resume of one or more job seekers, and the user may be an employment recruiter.

The foregoing describes only various aspects of embodiments of the disclosure, and modifications, obvious to those skilled in the art, can be made thereto without departing from the spirit and scope of the disclosed and claimed invention.

What is claimed is:

1. A computer-implemented method of converting a document to an image set comprising one or more images, the method comprising:
receiving a file containing the document;
generating a conversion specification comprising a unique document identifier and a set of image parameters associated therewith;
combining the conversion specification and the stored document into a conversion task object;
generating said image set of one or more images using the conversion task object; and
providing said generated image set to an image server.

2. The method of claim 1, further comprising:
providing the conversion specification to a conversion request queue; and
polling the conversion request queue,
wherein the conversion task object is placed in the conversion request queue prior to said generating, and wherein, in response to said polling, said combining is performed.

3. The method of claim 1, wherein the image server is accessible through the Web.

4. The method of claim 1, wherein said file is received in a Web server.

5. The method of claim 1, further comprising assigning a unique identifier to the document.

6. The method of claim 5, wherein the unique document identifier comprises a uniform resource locator (URL).

7. The method of claim 1, wherein said generating the image set further comprises evaluating a conversion load of each of a plurality of converters and assigning one of said converters to convert said conversion task object based upon a relative conversion load thereof.

8. The method of claim 1, wherein said image set comprises one or more PNG images.

9. The method of claim 1, further comprising configuring a set of conversion parameters through an operator interface.

10. The method of claim 9, wherein said operator interface is enabled through a Web server.

11. The method of claim 1, further comprising annotating one or more images of the image set with annotation data.

12. The method of claim 11, further comprising storing the annotation data.

13. The method of claim 12, wherein said annotation data is stored separately from the image server.

14. The method of claim 1, wherein said receiving a file comprises uploading the document to a Web server over the internet.

15. The method of claim 1, wherein the document comprises a resume of a job seeker.

16. A Web-based method of viewing a document, the method comprising:
receiving a document retrieval request from a user, said document retrieval request comprising information relating to a particular document and image viewing capabilities and/or preferences indicated by the user;
selecting an image set comprising one or more images from an image server based, at least in part, on the particular document and the available image viewing capabilities and/or preferences; and
providing the selected image set to the user, wherein the selected image set is optimized at least with respect to the image viewing capabilities and/or preferences indicated by the user.

17. The method of claim 16, wherein said document retrieval request is provided to a Web server by the user.

18. The method of claim 16, wherein the particular document comprises a resume of a job seeker.

19. The method of claim 16, wherein the user is a recruiter.

20. The method of claim 16, wherein the document retrieval request comprises a request for multiple documents.

21. The method of claim 16, further comprising sharing one or more images of the particular document with other users.

22. The method of claim 21, further comprising enabling collaboration between the user and one or more other users in a review of the particular document.

23. The method of claim 16, further comprising superimposing supplemental information on one or more of the images comprising the image set and storing the supplemental information.

24. The method of claim 16, further comprising loading a document viewer in a Web browser of the user.

25. A computer-implemented system for viewing documents, the system comprising:
a first node configured to receive a document file from a first user, assign a unique identifier thereto, and generate a conversion specification comprising the unique identifier and a set of image parameters relating to the document file;
a conversion feeder configured to receive the conversion specification and the document file and convert the conversion specification and the document file into a conversion task object,
at least one converter operatively coupled to the conversion feeder and configured to generate, from the conversion task object, an image set comprising one or more images related to the document file; and
an image server that receives the generated image set.

26. The system of claim 25, wherein the first node comprises a Web server in communication with the Internet.

27. The system of claim 25, further comprising a second node through which a second user can access said one or more images of the image set.

28. The system of claim 27, wherein the second node comprises a Web server in communication with the Internet.

29. The system of claim 25, further comprising a conversion request queue arranged to receive the conversion specification and, in response to a polling request, provide the conversion specification to the conversion feeder.

30. The system of claim 29, wherein the polling request is received from the conversion feeder.

31. The system of claim 25, further comprising a file storage system operatively coupled to the first node and configured to store the document file and the assigned unique identifier therein.

32. The system of claim 25, wherein the document file comprises a resume received from the first user via the Internet.

33. The system of claim 25, further comprising a load balancer operatively coupled to an output of the conversion feeder, wherein said at least one converter comprises a plurality of selectable converters,
wherein the load balancer evaluates a conversion load of each of the plurality of converters and assigns one of said plurality of selectable converters to convert said conversion task object based upon a relative conversion load thereof.

34. The system of claim 25, wherein said converter provides the image set as one or more PNG images.

35. The system of claim 25, further comprising an operator interface with the first node through which a set of conversion parameters may be configured.

36. The system of claim 25, further comprising a storage medium in which annotation data relating to one or more images of the image set are stored.

37. The system of claim 27, wherein the second node is configured to receive a document retrieval request from the second user, said document retrieval request comprising information relating to a particular document and the second user's image viewing capabilities and/or preferences.

38. The system of claim 37, wherein the first node and the second node comprise a Web server in communication with the Internet.

39. The system of claim 37, further comprising an image selector operably connected to the second node and the image server, wherein, in response to a request by the second user, the image selector selects a desired image set comprising one or more images from the image server based, at least in part, on a desired document and image viewing capabilities and/or preferences of the second user.

40. The system of claim 39, wherein the selected one or more images are optimized at least with respect to the image viewing capabilities of the second user, and an optimized image set is provided to the second user.

41. The system of claim 27, wherein the second user is an employment recruiter and the document comprises a resume of the first user.

42. The system of claim 27, wherein a document retrieval request received from the second user comprises a request for multiple documents.

43. The system of claim 25, wherein one or more images of a particular document is shared with other users through multiple interfaces with the Web server.

44. The system of claim 27, further comprising a document viewer loaded in a Web browser of the second user.

45. A document image converter, the converter comprising:
an input configured to receive a conversion task from a client application, wherein the conversion task comprises a conversion specification and a document, and wherein the conversion specification comprises a unique document identifier and a set of image parameters associated with the document;
a conversion controller; and
a renderer operatively coupled to the conversion controller,
wherein the renderer accesses the document and generates a set of images comprising one image for each page of the document, wherein said conversion controller provides said set of images to said client application.

46. The converter of claim 45, further comprising an image optimizer operatively coupled to the conversion controller and the renderer, wherein said image optimizer converts at least one image of said set of images into at least one optimized image and returns said at least one optimized image to the client application via said conversion controller.

47. The converter of claim 45, further comprising at least one storage device operatively connected to said conversion controller and said renderer, wherein the conversion controller stores the document in the at least one storage device and passes an address of the stored document to the renderer.

48. The converter of claim 47, wherein said address comprises a uniform resource locator (URL) address.

49. The converter of claim 45, wherein said document comprises a resume of a job seeker.

50. A document browser application, the application comprising:
a software interface with an Internet Web browser that enables the application to run within a Web browser window;
a user interface enabled with a host computer system through which a user sends a document retrieval request to a server application, said document retrieval request at least comprising information relating to viewing capabilities of the host computer system,
said user interface comprising computer executable code therein which, when executed by the host computer system enables user-interactive controls for navigating multiple pages of a retrieved document, user-initiated collaboration with other users related to the retrieved document, and display of one or more pages of the retrieved document.

51. The document browser application of claim 50, wherein said document retrieval request comprises a request to retrieve multiple documents, wherein said user-interactive controls enable navigation of said multiple documents and any pages contained therein.

52. The document browser application of claim 50, wherein said user-initiated collaboration comprises annotating a retrieved document with supplemental information.

53. The document browser application of claim 52, wherein said supplemental information annotated on said retrieved document is provided to a display of the host computer system.

54. The document browser application of claim 53, wherein said supplemental information is superimposed on or placed adjacent to an image of the retrieved document on the display.

55. The document browser application of claim 50, wherein said retrieved document comprises a resume of a job seeker.

56. The document browser application of claim 50, wherein said user is an employment recruiter.
